(19) United States
(12) Patent Application Publication
(10) Pub. No.: US 2025/0279911 A1
(43) Pub. Date: Sep. 4, 2025

(54) COMMUNICATION SYSTEM AND COMMUNICATION METHOD

(71) Applicant: DENSO CORPORATION, Kariya-city (JP)

(72) Inventors: TAKUTO YOSHIDA, Kariya-city (JP); YASUHIRO KOTANI, Kariya-city (JP)

(21) Appl. No.: 19/034,717

(22) Filed: Jan. 23, 2025

(30) Foreign Application Priority Data
Feb. 29, 2024 (JP) 2024-029823

(51) Int. Cl. H04L 12/437; H04B 1/74; H04L 12/40

(52) U.S. Cl. CPC H04L 12/437; H04B 1/74; H04L 12/40195

(57) ABSTRACT

A communication system includes multiple relay devices and an SDN controller. The multiple relay devices are connected in a ring shape on multiple communication paths via which multiple communication devices communicate with one another. The SDN controller is configured to manage the multiple relay devices. The multiple relay devices each is configured to receive a frame transmitted from the SDN controller and transmit the received frame to multiple adjacently connected relay devices among the multiple relay devices.

### CROSS REFERENCE TO RELATED APPLICATION

The present application claims the benefit of priority from Japanese Patent Application No. 2024-029823 filed on Feb. 29, 2024. The entire disclosure of the above application is incorporated herein by reference.

### TECHNICAL FIELD

The present disclosure relates to a communication system including multiple relay devices and an SDN controller.

### BACKGROUND

There has been known a technique for shortening a period during which communication is interrupted due to congestion occurred in a communication path of a communication system, which includes multiple relay devices and an SDN controller.

### SUMMARY

A communication system includes multiple relay devices connected in a ring shape on multiple communication paths via which multiple communication devices communicate with one another. The communication system includes a software defined network (SDN) controller configured to manage the multiple relay devices. At least one of the multiple relay devices is communicatively connected to the SDN controller. Each of the multiple relay devices includes a frame receiving unit configured to receive a frame transmitted from the SDN controller, and a frame transmitting unit configured to transmit the received frame to multiple adjacently connected relay devices among the multiple relay devices.

### BRIEF DESCRIPTION OF DRAWINGS

Objects, features and advantages of the present disclosure will become apparent from the following detailed description made with reference to the accompanying drawings. In the drawings:

FIG. 1 is a block diagram showing a configuration of a communication system;

FIG. 2A is a schematic diagram showing a table of a relay device in an example of a destination port before change according to an embodiment of the present disclosure;

FIG. 2B is a schematic diagram showing a table of another relay device in the example of the destination port before change;

FIG. 2C is a schematic diagram showing a table of another relay device in the example of the destination port before change;

FIG. 2D is a schematic diagram showing a table of another relay device in the example of the destination port before change;

FIG. 3A is a table of a relay device in an example of a destination port after change according to an embodiment of the present disclosure;

FIG. 3B is a table of another relay device in the example of the destination port after change;

FIG. 3C is a table of another relay device in the example of the destination port after change;

FIG. 3D is a table of another relay device in the example of the destination port after change;

FIG. 4A is a schematic diagram showing a failure notification is notified to an SDN controller in an example of a failure recovery procedure;

FIG. 4B is a schematic diagram showing update of communication settings in the example of the failure recovery procedure;

FIG. 4C is a schematic diagram showing an execution of communication using a new communication path in the example of the failure recovery procedure;

FIG. 5A is a schematic diagram showing a table of a relay device in an example of a destination port before change according to a conventional configuration;

FIG. 5B is a schematic diagram showing a table of another relay device in the example of the destination port before change according to the conventional configuration;

FIG. 5C is a schematic diagram showing a table of another relay device in the example of the destination port before change according to the conventional configuration;

FIG. 5D is a schematic diagram showing a table of another relay device in the example of the destination port before change according to the conventional configuration;

FIG. 6A is a schematic diagram showing a table of a relay device in an example of a destination port after change according to the conventional configuration;

FIG. 6B is a schematic diagram showing a table of another relay device in the example of the destination port after change according to the conventional configuration;

FIG. 6C is a schematic diagram showing a table of another relay device in the example of the destination port after change according to the conventional configuration; and

FIG. 6D is a schematic diagram showing a table of another relay device in the example of the destination port after change according to the conventional configuration.

### DETAILED DESCRIPTION

After a study carried out by the inventors of the present application, it is found that a conventional configuration disclosed in a related art does not take into consideration the time required to establish a communication path when a failure occurs in the communication path. There is a possibility that a relatively long time is required to establish a communication path.

According to an aspect of the present disclosure, a communication system includes multiple relay devices and an SDN controller. The multiple relay devices are connected in a ring shape on multiple communication paths via which multiple communication devices communicate with one another. The SDN controller is configured to manage the multiple relay devices.

At least one of the multiple relay devices is communicatively connected to the SDN controller. Each of the relay devices R1 to R4 includes a frame receiving unit and a frame transmitting unit. The frame receiving unit is configured to receive a frame transmitted from the SDN controller. The frame transmitting unit is configured to transmit the received frame to multiple adjacently connected relay devices among the multiple relay devices.

According to the above configuration, the relay device transmits the frame, which is transmitted from the SDN controller, to multiple relay devices connected adjacent to ego device so that the frame can be transferred to all of the relay devices more quickly compared with the conventional configuration. Therefore, the time required to establish a communication path can be further reduced.

### 1. EMBODIMENT

The following will describe an embodiment of the present disclosure with reference to the drawings.

### 1-1. Configuration

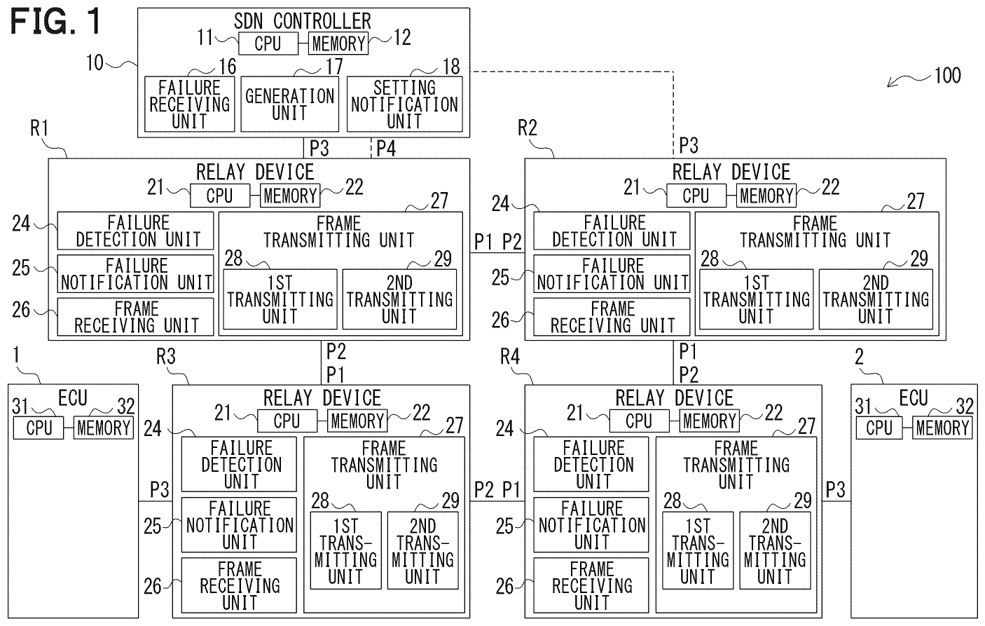

As shown in FIG. 1, a communication system 100 according to the present embodiment includes an Ethernet (registered trademark) network system mounted on a vehicle, such as a passenger car. The network is not limited to Ethernet, and may be any network using a different communication protocol. The optional communication protocol may be LIN, CAN, FlexRay, MOST, or CXPI. LIN is an abbreviation for Local Interconnect Network. CAN is an abbreviation for Controller Area Network. MOST is an abbreviation for Media Oriented Systems Transport. CXPI is an abbreviation for Clock Extension Peripheral Interface.

As shown in FIG. 1, the communication system 100 includes multiple electronic control units (ECU) 1 and 2 (hereinafter, referred to as ECUs 1 and 2), an SDN controller 10, and multiple relay devices R1, R2, R3, and R4 (hereinafter, referred to as R1 to R4). These components are connected with one another by communication lines.

Note that ECU is an abbreviation for electronic control unit, and SDN is an abbreviation for software defined network. The ECUs 1 and 2 correspond to the communication devices in the present disclosure. The number of ECUs is not limited to two. For example, three or more ECUs may be provided in the communication system 100. The number of relay devices is not limited to four. For example, three or more than four relay devices may be provided in the communication system 100. The relay devices R1 to R4 may be domain ECUs, each of which controls a domain of the vehicle. The relay devices R1 to R4 may be zone ECUs, each of which controls various ECUs in a zone of the vehicle. The zone of the vehicle may be a front zone, a rear zone, a left zone, or a right zone of the vehicle.

The ECUs 1 and 2 each includes a CPU 31 and a memory 32. The memory 32 stores programs to be executed by the CPU 31 for performing predetermined functions. The ECUs 1 and 2 each is connected to sensors, actuators, or the like, which are not shown in the drawings. For example, the ECUs 1 and 2 each executes a program stored in the memory 32 to implement a function of transmitting data (for example, frames) acquired from a sensor to another ECU via the relay devices R1 to R4. For example, the ECU may implement a function of operating an actuator based on data received from other ECUs via the relay devices R1 to R4. The ECUs 1 and 2 each has a function of transmitting and receiving data to and from the relay devices R1 to R4 connected thereto.

The SDN controller 10 includes a CPU 11 and a memory 12. The memory 12 stores programs to be executed by the CPU 11 to perform predetermined functions. By executing a program stored in the memory 12, the SDN controller 10 performs a function of a general SDN controller, such as the centralized control of network devices, such as the relay devices R1 to R4 and the dynamic change of network configuration settings, or the like The SDN controller 10 is configured to manage multiple relay devices R1 to R4.

The SDN controller 10 transmits commands to the relay device R1 and to the multiple other relay devices R2 to R4 connected via the relay device R1, such that the relay devices R1 to R4 each sets or changes the network configuration, or the like. In the present disclosure, the SDN controller 10 functions as a failure receiving unit 16, a generation unit 17, and a setting notification unit 18.

The failure receiving unit 16 is configured to receive link failure notifications from the relay devices R1 to R4. The generation unit 17 is configured to generate, based on link failure information, new network configuration information for performing a communication by avoiding the failed link. The setting notification unit 18 is configured to notify the relay devices R1 to R4 of the new network configuration by transmitting the new network configuration information to the relay devices R1 to R4.

Each of the relay devices R1 to R4 has a function of a gateway device. As the gateway device, each of the relay devices R1 to R4 relays a communication between the ECUs 1 and 2, or between the SDN controller 10 and one of the relay devices R1 to R4. Each of the relay devices R1 to R4 is required to have at least the function of a layer 2 switch. The relay devices R1 to R4 are connected in a ring shape on each of multiple communication paths, via which the ECU 1 and the ECU 2 communicate with one another.

The relay devices R1 to R4 perform communications for relaying frames that are data conforming to a predetermined communication standard, for example, frames conforming to the Ethernet standard in the present embodiment. For this reason, each of the relay devices R1 to R4 has multiple communication ports (hereinafter, referred to as ports) P1 to P4 for transmitting and receiving frames, and a transceiver (not shown) that executes a communication process for relaying the frames in accordance with the Ethernet standard. The number of ports included in each relay device is not limited to four. For example, the number of ports may be set to any number equal to or greater than three.

Among the multiple relay devices R1 to R4, the relay device R1 is directly connected to the SDN controller 10 and is able to directly communicate with the SDN controller 10. The relay device R1 is communicatively connected to the SDN controller 10 without communicating through multiple communication paths for performing a communication between the ECU 1 and the ECU 2.

Each of the relay devices R1 to R4 includes a microcomputer having a CPU 21 and a memory 22. The memory 22 stores programs to be executed by the CPU 21 to perform predetermined functions. The memory 22 stores network configuration information, for example, a communication path table, a MAC address table, or the like, in a rewritable storage area.

Each of the relay devices R1 to R4 executes a program stored in the memory 22 to implement the following functional units. Each of the multiple relay devices R1 to R4 functions as a failure detection unit 24, a failure notification unit 25, a frame receiving unit 26, and a frame transmitting unit 27. The frame transmitting unit 27 further functions as a first transmitting unit 28 and a second transmitting unit 29.

The failure detection unit 24 is configured to detect a link failure in each of the multiple communication paths. The failure notification unit 25 is configured to notify the SDN controller 10 of a link failure notification when the link failure is detected.

The frame receiving unit 26 is configured to receive a frame transmitted from the SDN controller 10. The frame transmitting unit 27 is configured to transmit a frame. The first transmitting unit 28 of the frame transmitting unit 27 is configured to transmit the frame received by the frame receiving unit 26 to multiple adjacently connected relay devices R2, R3 out of the multiple relay devices R1 to R4. In the present disclosure, “adjacently connected” refers to being connected by only one link, or the number of hops is one.

The second transmitting unit 29 of the frame transmitting unit 27 is configured to, upon receiving a frame destined to the SDN controller 10, transmit the received frame to multiple adjacently connected relay devices.

Each of the ECUs 1 and 2, the SDN controller 10, and the relay devices R1 to R4 includes one or more microcomputers.

The method of implementing the functions of units included in ECUs 1 and 2, the SDN controller 10, and the relay devices R1 to R4 is not limited to in software manner. Alternatively, partial or all of the functions of units may be implemented using one or more hardware circuits. For example, when the above-described functions may be implemented by an electronic circuit, which is a hardware circuit, the electronic circuit may be implemented by a digital circuit, an analog circuit, or a combination of digital circuit and analog circuit.

In the communication system 100, the SDN controller 10 is connected to the port P3 of the relay device R1. The port P1 of the relay device R1 is connected to the port P2 of the relay device R2, and the port P1 of the relay device R2 is connected to the port P2 of the relay device R4. The port P1 of the relay device R4 is connected to the port P2 of the relay device R3, and the port P1 of the relay device R3 is connected to the port P2 of the relay device R1.

As described above, the relay devices R1 to R4 are connected in a ring shape by connecting each of the ports P1 and P2 to the ports P1 and P2 of the adjacent relay devices. The ring shape is also referred to as a loop.

The ECU 1 is connected to the port P3 of the relay device R3, and the ECU 2 is connected to the port P3 of the relay device R4.

Among the ports P1 to P4 of each of the relay devices R1 to R4, the ports P3 and P4 that are not used for the ring connection can be connected to communication devices, such as the SDN controller 10 and the ECUs 1 and 2.

For example, when the relay device R1 is used as a start point among the relay devices R1 to R4, there are two communication paths: a left-handed (counterclockwise) communication path from the relay device R1 to the relay device R3, and a right-handed (clockwise) communication path from the relay device R1 to the relay device R2. There are two communication paths between ECU 1 and ECU 2: a communication path that starts from the ECU 1 and passes through the relay devices R3 and R4 in order to reach the ECU 2, and a communication path that starts from the ECU 1 and passes through the relay devices R3, R1, R2, and R4 in order to reach the ECU 2.

The ring-shaped communication path in the communication system 100 can function as two communication paths. Among the two communication paths between the ECU 1 and the ECU 2, the communication path having the fewer number of hops is usually adopted.

### 1-2. Network Configuration Information

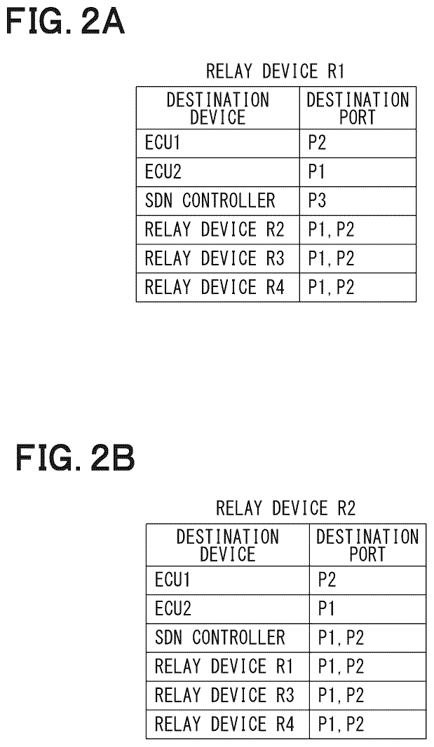

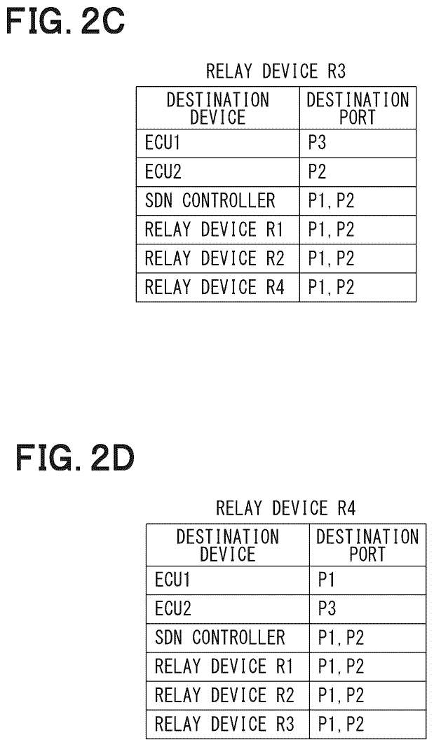

Each of the relay devices R1 to R4 has network configuration information, for example, as shown in FIG. 2A to 2D. The network configuration information includes at least a table that associates destination devices of data with destination ports of data. The destination device is a device to which data is to be transmitted, and is specified by a MAC address or the like included in the received data. The destination port is the port used for transmitting the data. The destination port is also referred to as a transmission port, because it is the port used for transmitting the data.

As shown in FIG. 2A, the network configuration information in the relay device R1 is set so that data destined to the ECU 1 is transmitted from the port P2, and data destined to the ECU 2 is transmitted from the port P1. The network configuration information in the relay device R1 is set so that data destined to the SDN controller 10 is transmitted from the port P3. The network configuration information in the relay device R1 is set so that data destined to the relay devices R2, R3, and R4 is transmitted from the ports P1 and P2.

In the relay device R1, data destined to the relay devices R2, R3, and R4 is transmitted from multiple ports P1 and P2, and the multiple adjacent relay devices R2 and R3 can receive the data destined to the relay devices R2, R3, and R4.

As shown in FIG. 2B, the network configuration information in the relay device R2 is set so that data destined to the ECU 1 is transmitted from the port P2, and data destined to the ECU 2 is transmitted from the port P1. The network configuration information in the relay device R2 is set so that data destined to the SDN controller 10 is transmitted from the ports P1 and P2. The network configuration information in the relay device R2 is set so that data destined to the relay devices R1, R3, and R4 is transmitted from the ports P1 and P2.

In the relay device R2, data destined to the relay devices R1, R3, and R4 is transmitted from multiple ports P1 and P2, and the multiple adjacent relay devices R1 and R4 can receive the data destined to the relay devices R1, R3, and R4. In the relay device R2, data destined to the SDN controller 10 is also transmitted from the ports P1 and P2, and the data destined to the SDN controller 10 can also be received by the adjacently connected relay devices R1 and R4.

As shown in FIG. 20, the network configuration information in the relay device R3 is set so that data destined to the ECU 1 is transmitted from the port P3, and data destined to the ECU 2 is transmitted from the port P2. The network configuration information in the relay device R3 is set so that data destined to the SDN controller 10 is transmitted from the ports P1 and P2. The network configuration information in the relay device R3 is set so that data destined to the relay devices R1, R2, and R4 is transmitted from the ports P1 and P2.

In the relay device R3, the multiple relay devices R1 and R4 arranged adjacent to the relay device R3 can receive the data destined to the SDN controller 10 and the data destined to the relay devices R1, R2, and R4.

As shown in FIG. 2D, the network configuration information in the relay device R4 is set so that data destined to the ECU 1 is transmitted from the port P1, and data destined to the ECU 2 is transmitted from the port P3. The network configuration information in the relay device R4 is set so that data destined to the SDN controller 10 is transmitted from the ports P1 and P2. The network configuration information in the relay device R4 is set so that data destined to the relay devices R1, R2, and R3 is transmitted from the ports P1 and P2.

In the relay device R4, the multiple relay devices R2 and R3 arranged adjacent to the relay device R4 can receive the data destined to the SDN controller 10 and the data destined to the relay devices R1, R2, and R3.

With the above-described configuration, each of the relay devices R1 to R4 is physically and logically connected to multiple other relay devices R1 to R4 so that data destined to other relay devices R1 to R4 can be transmitted to multiple adjacently connected relay devices R1 to R4.

### 1-3. Change Process of Network Configuration Information

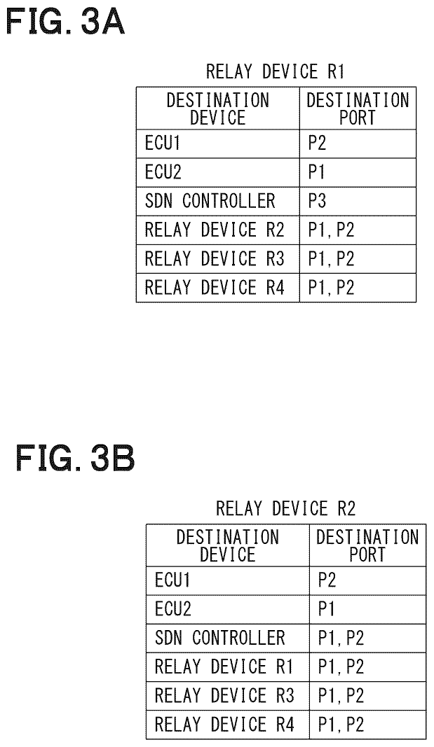

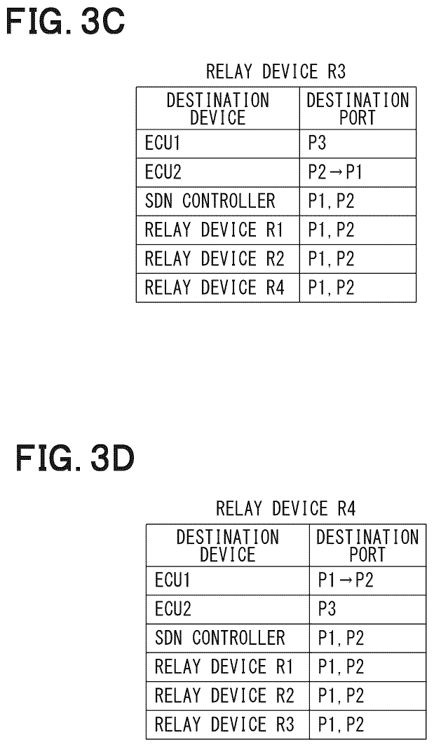

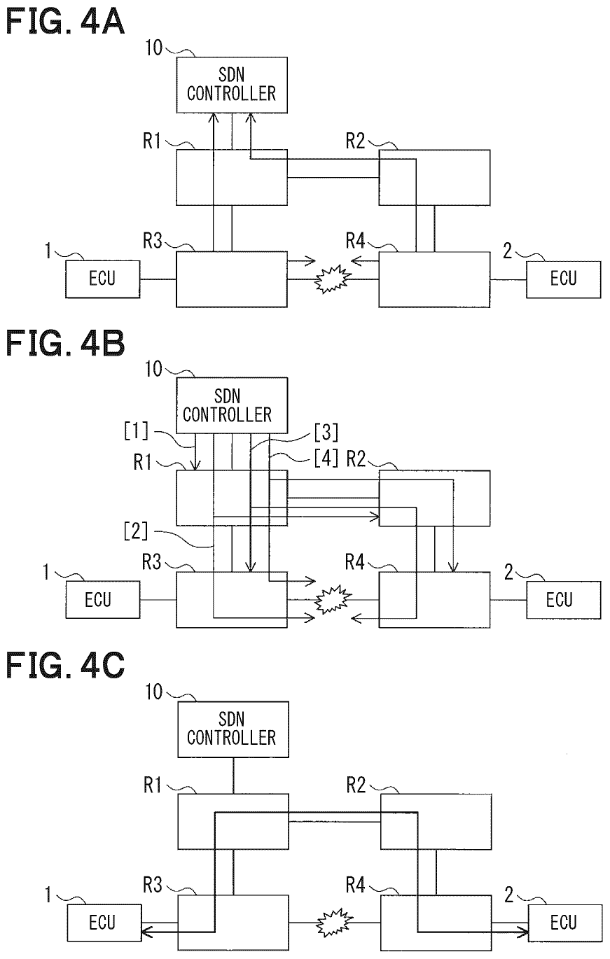

The SDN controller 10 can arbitrarily change the network configuration information stored in the relay devices R1 to R4. This process will be described with reference to FIG. 3A to FIG. 3D and FIG. 4A to FIG. 4C.

The SDN controller 10 can change the network configuration information even in an initial setup. In the present embodiment, as shown in FIG. 4A, a description will be given assuming that a failure, such as a disconnection has occurred in a link (e.g., a communication line) connecting the relay device R3 with the relay device R4. When a failure occurs in the link connecting the relay device R3 with the relay device R4, the failure detection units 24 of the relay devices R3 and R4 detect the failure. For example, the failure detection unit 24 may determines that a failure has occurred in the link when no response is received within a predetermined period after transmitting the data.

When the failure detection unit 24 of each relay device R3, R4 determines that a failure has occurred, the failure notification unit 25 of each relay device R3, R4 transmits, to the SDN controller 10, a link failure notification indicating that a failure has occurred in the link, in accordance with the network configuration information. The link failure notification includes information for identifying the link in which the failure has occurred. The link failure notification is transmitted from the ports P1 and P2 of each of the relay devices R3 and R4.

The link failure notification transmitted from the relay device R3 is received by the SDN controller 10 via the relay device R1. The link failure notification transmitted from the relay device R4 is received by the SDN controller 10 via the relay devices R2 and R1. At this time, the frame receiving unit 26 of each of the relay devices R1 and R2 recognizes the link failure notification, and the second transmitting unit 29 of each of the relay devices R1 and R2 transmits the link failure notification as data destined to the SDN controller 10.

In the SDN controller 10, the failure receiving unit 16 recognizes the link failure notification, and the generation unit 17 generates information (i.e., new network configuration information) for reconfiguring the communication paths to perform the communication by avoiding the link in which the failure has occurred. As shown in FIG. 3C, the SDN controller 10 changes the network configuration information of the relay device R3 so that data destined to the ECU 2 is transmitted from the port P1. As shown in FIG. 3D, the SDN controller 10 changes the network configuration information of the relay device R4 so that data destined to the ECU 1 is transmitted from the port P2.

As shown in FIG. 4B, the network configuration information after change is transmitted to the relay devices R1 to R4. Specifically, the setting notification unit 18 transmits the changed network configuration information shown in FIG. 3A to the relay device R1 that is directly connected to the SDN controller 10 as shown by [1] in FIG. 4B. Then, the setting notification unit 18 transmits the changed network configuration information shown in FIG. 3B and FIG. 3C to the relay devices R2 and R3 adjacently connected to the relay device R1 as shown by [2] in FIG. 4B.

Then, the setting notification unit 18 transmits the changed network configuration information shown in FIG. 3D to the relay device R4 as shown by [3] in FIG. 4B. In the example according to the present embodiment, since the network configuration information in the relay devices R1 and R2 is not changed, the process of transmitting the network configuration information to the relay devices R1 and R2 may be omitted.

According to the above-described configuration, the relay devices R1 to R4 that have received the network configuration information from the SDN controller 10 update their respective network configuration information. After updating the respective network configuration information in the relay devices R1 to R4, as shown in FIG. 4C, a new communication path between the ECU 1 and the ECU 2 is established. The ECU 1 can transmit data to the ECU 2 by relaying the data via the relay devices R3, R1, R2, and R4 in the described order.

### 1-4. Comparison with Conventional Configuration

The configuration of the present embodiment includes the network configuration information shown in FIG. 2A to FIG. 2D. That is, the relay devices R1 to R4 are configured to be physically and logically connected to other relay devices R1 to R4 via multiple communication paths. The data, which is destined to the SDN controller 10 and the relay devices R1 to R4, is set to be transmitted from both of the port P1 and the port P2.

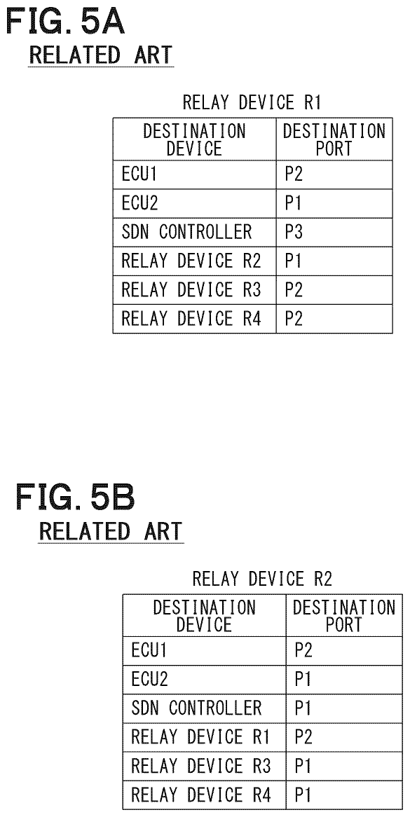

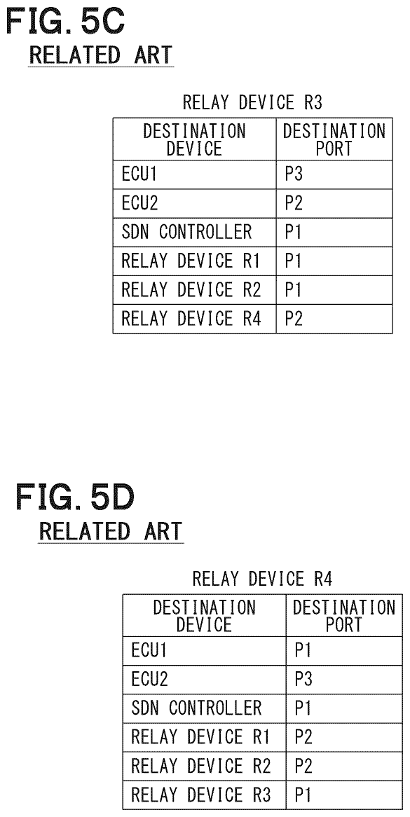

According to the conventional configuration, network configuration information shown in FIG. 5A to FIG. 5D is provided as an example. The data destined to the SDN controller 10 and the relay devices R1 to R4 are set to be transmitted only from one port, that is, the port P1 or P2.

As shown in FIG. 5A, the network configuration information of the relay device R1 is set so that data destined to the relay device R2 is transmitted only from the port P1, and data destined to the relay devices R3 and R4 is transmitted only from the port P2. As shown in FIG. 5B, the network configuration information of the relay device R2 is set so that data destined to the relay device R1 is transmitted only from the port P2, and data destined to the SDN controller 10 and the relay devices R3 and R4 is transmitted only from the port P1.

As shown in FIG. 5C, the network configuration information of the relay device R3 is set so that data destined to the SDN controller 10 and the relay devices R1 and R2 is transmitted only from the port P1, and data destined to the relay device R4 is transmitted only from the port P2. As shown in FIG. 5D, the network configuration information of the relay device R4 is set so that data destined to the SDN controller 10 and the relay device R3 is sent only from the port P1, and data destined to the relay devices R1 and R2 is transmitted only from the port P2.

In such a conventional configuration, the relay devices R1 to R4 are physically connected to the multiple relay devices R1 to R4 via multiple communication paths, but are logically connected to each other via only one communication path. For this reason, when updating the network configuration information, it is first necessary to carry out a process of establishing a new logical connection among the relay devices R1 to R4. At this time, the destination port toward the SDN controller 10 and the destination ports toward the relay devices R1 to R4 need to be changed. Thus, more setting information need to be dynamically changed compared with the configuration of present embodiment described above, and management of the communication paths become more complicated.

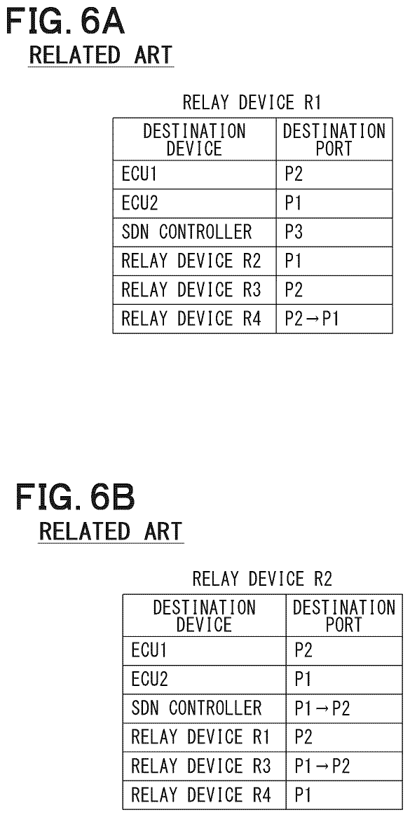

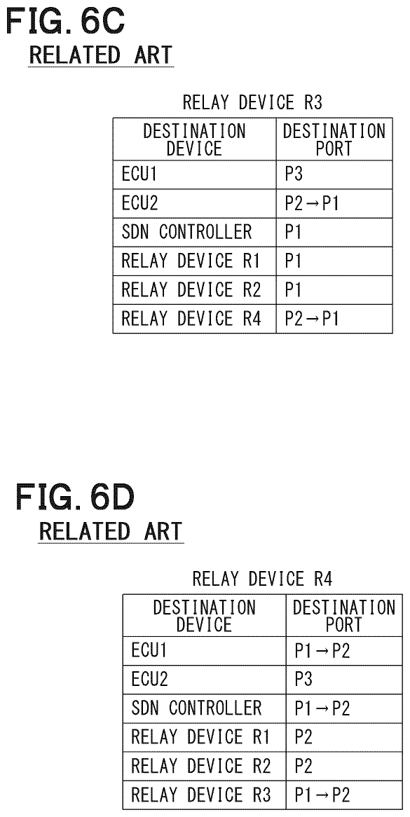

As shown in the example of FIG. 4A, when a failure occurs between the relay device R3 and the relay device R4, in a system having the conventional configuration, it is necessary to change the port destined to the SDN controller 10 and the ports destined to the relay devices R1 to R4 as shown in FIG. 6A to FIG. 6D. That is, in the conventional configuration, additional process for changing the ports is necessary, compared with the present embodiment described above. In a system having the conventional configuration, a logical link is established to avoid a failure first, and a change process is executed to sequentially change the port destined to the SDN controller 10 and the ports destined to the relay devices R1 to R4 in the network configuration information. Finally, the ports destined to the ECUs 1 and 2 are changed in the same manner as in the present embodiment.

### 1-5. Effects

According to the present embodiment described above, the following effects are achieved.

(1a) According to an aspect of the present disclosure, a communication system 100 includes multiple relay devices R1 to R4 and an SDN controller 10. The multiple relay devices R1 to R4 are connected in a ring shape on multiple communication paths via which multiple communication devices (for example, ECU 1 and ECU 2) communicate with one another. The SDN controller 10 is configured to manage the multiple relay devices R1 to R4.

At least one relay device R1 among the multiple relay devices R1 to R4 is communicatively connected to the SDN controller 10. In particular, the relay device R1 is communicatively connected to the SDN controller 10 via a single communication path, without going through multiple communication paths, via which the ECU 1 and the ECU 2 communicate with one another.

Each relay device R1 to R4 includes a frame receiving unit 26 and a frame transmitting unit 27. The frame receiving unit 26 is configured to receive a frame transmitted from the SDN controller 10. The frame transmitting unit 27, that is, the first transmitting unit 28 is configured to transmit the frame received by the frame receiving unit 26 to multiple adjacently connected relay devices R2, R3 among the multiple relay devices R1 to R4.

According to the above-described configuration, each relay device R1 to R4 transmits the frame transmitted from the SDN controller 10 to the multiple relay devices R1 to R4 that are connected adjacent to ego device, such that the frames can be transferred to all of the relay devices R1 to R4 more quickly than in the conventional configuration. Therefore, the time required to establish a communication path can be further reduced.

(1b) In the present embodiment, each of the relay devices R1 to R4 further includes a second transmitting unit 29. The second transmitting unit 29 is configured to, upon receiving a frame destined to the SDN controller 10, transmit the received frame to the multiple relay devices R1 to R4 connected adjacently to ego device.

According to such a configuration, the multiple relay devices R1 to R4 can relay frames destined to the SDN controller 10 to multiple other relay devices R1 to R4. Therefore, even if a communication abnormality occurs in one communication path, a frame destined to the SDN controller 10 can be transmitted to the SDN controller 10 more quickly.

(1c) According to an aspect of the present embodiment, each of the multiple relay devices R1 to R4 further includes a failure detection unit 24 and a failure notification unit 25. The failure detection unit 24 is configured to detect a link failure in each of the multiple communication paths. The failure notification unit 25 is configured to notify the SDN controller 10 of a link failure notification when the link failure is detected.

The SDN controller 10 includes a failure receiving unit 16, a generation unit 17, and a setting notification unit 18. The failure receiving unit 16 is configured to receive link failure notifications from the relay devices R1 to R4. The generation unit 17 is configured to generate, based on the link failure information, new network configuration information by avoiding the failed link. The setting notification unit 18 is configured to notify the new network configuration information.

According to the above-described configuration, when each of the relay devices R1 to R4 detects a failure, the SDN controller 10 can generate and notify new network configuration information for performing communication by avoiding the link with a failure of communication path. With the above configuration, the network configuration information can be notified to all of the relay devices R1 to R4 at an earlier stage compared with the conventional configuration.

### 2. OTHER EMBODIMENTS

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

(2a) In the above embodiment, the SDN controller 10 is connected only to the port P3 of the relay device R1. The present disclosure is not limited to this configuration. For example, as shown by the dashed lines in FIG. 1, the SDN controller 10 may be connected to the ports P3 and P4 of the relay device R1 in duplex manner. Alternatively, the SDN controller 10 may be directly connected to both of the relay device R1 and the relay device R2.

The SDN controller 10 may be directly connected to two or more relay devices R1 to R4 without going through multiple communication paths. According to such a configuration, even though a communication failure occurs between the SDN controller 10 and one of the relay devices R1 to R4, redundancy is provided, so that a communication possible state can be ensured.

(2b) In the above embodiment, the SDN controller 10 generates the new network configuration information in response to occurrence of a link failure and notifies the relay devices R1 to R4 of the new network configuration information. The present disclosure is not limited to this configuration. For example, each of the relay devices R1 to R4 may be equipped with an information acquisition unit that acquires the communication status of the link to which ego device is connected. When the communication status satisfies a predetermined condition, the information acquisition unit notifies the SDN controller 10, and the SDN controller 10 generates new network configuration information. The predetermined condition may include that the communication quality in the link is equal to or lower than a predetermined level, or that the communication data amount in the link is equal to or greater than a predetermined threshold.

(2c) In the above embodiment, the SDN controller 10 generates the new network configuration information in response to occurrence of a link failure and notifies the relay devices R1 to R4 of the new network configuration information. The present disclosure is not limited to this configuration. For example, the SDN controller 10 may generate new network configuration information when the vehicle switches to a specific mode. The vehicle switching to the specific mode may include at least any of switching to a driving assistance mode including autonomous driving level 2, switching to an autonomous driving mode including autonomous driving level 3 or higher, switching from the driving assistance mode or autonomous driving mode to a manual driving mode, switching to an over the air (OTA) mode for updating the vehicle system, or switching to a mode for collecting information within the vehicle system. The autonomous driving level is defined based on standards established by the Society of Automotive Engineers (SAE).

(2d) In the above embodiment, the SDN controller 10 is provided in addition to the relay devices R1 to R4. The present disclosure is not limited to this configuration. For example, one of the relay devices R1 to R4 may execute the functions of a general SDN controller, that is, the functions implemented by the failure receiving unit 16, the generation unit 17, and the setting notification unit 18. When one of the multiple relay devices has the function of a general SDN controller, there is no need to provide the SDN controller 10 separate from the relay devices.

(2e) Each of the devices described in the present disclosure (i.e., ECUs 1 and 2, SDN controller 10, relay devices R1 to R4) and the method used by each of these devices may be implemented by a special-purpose computer provided by configuring a processor and memory programmed to perform one or more functions embodied by a computer program. Alternatively, each of the devices and the method used by each of these devices described in the present disclosure may be implemented by a special purpose computer provided by configuring a processor with one or more special purpose hardware logic circuits. Alternatively, each of the devices and the method used by each of these devices described in the present disclosure may be implemented by one or more special-purpose computer configured by a combination of a processor and memory programmed to perform one or more functions and a processor configured by one or more hardware logic circuits. The computer program may be stored in a computer-readable non-transitory tangible storage medium as instructions to be executed by the computer. A method for implementing the functions of each unit included in each device does not necessarily include software, and all of the functions may be implemented by using one or multiple hardware circuits.

(2f) The multiple functions of one component in the above embodiments may be implemented by multiple components, or a function of one component may be implemented by multiple components. Further, multiple functions of multiple elements may be implemented by one element, or one function implemented by multiple elements may be implemented by one element. A part of the configuration in the above embodiments may be omitted as appropriate. At least a part of the configuration in one embodiment may be added to or substituted for the configuration of another embodiment.

(2g) In addition to the communication system 100 described above, the present disclosure can also be implemented in various forms, such as each device included in the communication system 100, a program for causing a computer to function as each device included in the communication system 100, a non-transitory tangible storage medium such as a semiconductor memory in which the above-described program is stored, and a communication method thereof.

What is claimed is:

1. A communication system comprising:
a plurality of relay devices connected in a ring shape on multiple communication paths via which a plurality of communication devices communicate with one another; and
a software defined network (SDN) controller configured to manage the plurality of relay devices,
wherein
at least one of the plurality of relay devices is communicatively connected to the SDN controller, and
each of the plurality of relay devices includes:
a frame receiving unit configured to receive a frame transmitted from the SDN controller; and
a frame transmitting unit configured to transmit the received frame to multiple adjacently connected relay devices among the plurality of relay devices.

2. The communication system according to claim 1, wherein
the frame transmitting unit corresponds to a first transmitting unit, and
each of the plurality of relay devices further includes a second transmitting unit configured to, upon receiving a frame destined to the SDN controller, transmit the received frame to the multiple adjacently connected relay devices.

3. The communication system according to claim 1, wherein
each of the plurality of relay devices further includes:
a failure detection unit configured to detect a failure of link in the multiple communication paths; and
a failure notification unit configured to notify the SDN controller of a link failure notification in response to the failure of link being detected, and
the SDN controller includes:
a failure receiving unit configured to receive the link failure notification transmitted from one of the plurality of relay devices;
a generation unit configured to generate new network configuration information based on the link failure notification to avoid the failure of link; and
a setting notification unit configured to notify the new network configuration information.

4. The communication system according to claim 1, wherein
the SDN controller is connected to two or more of the plurality of relay devices without going through the multiple communication paths.

5. A communication method comprising:
transmitting a frame from a software defined network (SDN) controller to a first relay device via a communication path; and
transmitting, from the first relay device, the frame transmitted from the SDN controller to a second relay device and a third relay device, which are adjacently connected to the first relay device,
wherein
the first relay device, the second relay device, and the third relay device are connected in a ring shape on multiple communication paths via which the first relay device, the second relay device, and the third relay device communicate with one another, and
the SDN controller manages the first relay device, the second relay device, and the third relay device.

6. The communication method according to claim 5, further comprising
upon receiving a frame destined to the SDN controller, transmitting, from each of the first to third relay devices, the received frame to the adjacently connected relay devices.

7. The communication method according to claim 5, further comprising
detecting, by each of the first to third relay devices, a failure of link in the multiple communication paths;
notifying the SDN controller of a link failure notification in response to the failure of link being detected;
receiving, by the SDN controller, the link failure notification transmitted from one of the first to third relay devices;
generating, by the SDN controller, new network configuration information based on the link failure notification to avoid the failure of link; and
notifying, by the SDN controller, the new network configuration information.

8. The communication method according to claim 5, wherein
the SDN controller is directly connected to two or more of the first to third relay devices without going through the multiple communication paths.
